(19) United States
(12) Patent Application Publication
(10) Pub. No.: US 2007/0237193 A1
(43) Pub. Date: Oct. 11, 2007

(54) Electro-absorption modulated laser using coupling for chirp correction

(76) Inventors: David Finzi, Haifa (IL); Uziel Koren, Yoqneam (IL)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/402,210

(22) Filed: Apr. 11, 2006

(51) Int. Cl. H01S 3/10; H01S 3/13

(52) U.S. Cl. 372/28; 372/29.01

(57) ABSTRACT

An electroabsorption modulated laser (EML) which uses coupling for chirp correction is disclosed.

### BACKGROUND AND SUMMARY

Integrated electroabsorption modulated lasers (EML's) are laser and electroabsorption modulator integrated on the same chip. These devices are used in the transmission of digital optical signals through long spans of optical fibers at high bit rates. The distance of transmission is often limited by dispersion of light in the fiber which is causing a large dispersion penalty (DP) as transmission distance is increased. The DP depends on the dynamic wavelength excursions (referred to as ‘dynamic chirp’) associated with amplitude modulation of the optical signal. The dynamic chirp is caused by the modulator during rise and fall times of the digital signal. In order to improve the transmission it is useful to control the chirp that is generated by the EML. For example, it is well known that in normal dispersion fiber negative chirp is required to increase transmission distance beyond about 60 km at 10 Gb/sec bit rates.

The chirp of an electroabsorption (EA) modulator depends on its bias work point. Lowering the bias voltage on the EA modulator causes the chirp to become negative. However, by lowering the bias voltage on the modulator the average optical power (AOP) emitted from the device also decreases due to the larger absorption of the modulator at the work point.

In contrast to a directly modulated laser, in an EML the modulation is achieved by an external EA modulator which transmits during the “on” high voltage bits and absorbs during the “off” negative voltage bits. This type of modulator introduces dynamic chirp and not adiabatic chirp, which is chirp during the constant part of the bit. Unfortunately, known EMLs are often limited in transmission performance.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a graphical representation of amplitude versus frequency of a direct modulated laser.

FIG. 2 is a simplified schematic diagram of a known laser and modulator (EML).

FIG. 3 is a simplified schematic diagram of an EML and modulator in accordance with an example embodiment.

FIG. 4 is a simplified schematic diagram of an EML and modulator in accordance with an example embodiment.

FIG. 5 is a simplified schematic diagram of an EML and modulator in accordance with an example embodiment.

FIG. 6 is a simplified schematic diagram of an EML and modulator in accordance with an example embodiment.

FIG. 7 is a graphical representation of the optical output signal of an EML without laser coupling.

FIG. 8 is a graphical representation of the calculated laser modulating current in accordance with an example embodiment.

FIG. 9 is a graphical representation of the optical output of an EML with electrical coupling in accordance with an example embodiment.

FIG. 10 is a graphical representation of a time-resolved chirp measurement of a known EML.

FIG. 11 is a graphical representation of a time-resolved chirp measurement of an EML with coupling in accordance with an example embodiment.

FIG. 12 are graphical representations of BER measurements of a known EML and an EML of an example embodiment.

FIG. 13 shows back to back eye diagrams of the known EML and an EML of an example embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

In accordance with the first example embodiment described herein, the laser frequency is changed to improve the transmission performance by adding a current signal to the laser that follows the modulator signal with a small time delay. In specific embodiments, a coupling capacitor C1 feed an RF current signal from the modulator drive signal to achieve this desired effect. By the first example embodiments, the inductor-resistor-capacitor provides an adiabatic chirp component that is delayed by a fraction of the bit period compared to the modulator signal which helps to reduce the modulator dynamic chirp. This comes at a cost of an increase in the adiabatic chirp of the device, but as described in further detail herein, the DP and transmission performance are less sensitive to adiabatic chirp so a significant overall improvement is obtained. In an alternative embodiment, the signal that changes the laser frequency is driven through a transistor (bipolar or FET) that effectively inverts the polarity of modulator response compared to other embodiments where the signal is applied directly. When the modulation signal is coupled into the laser using a relatively small coupling capacitor, the resulting laser frequency change will provide the necessary negative dynamic chirp to improve the overall performance of the integrated device.

In the example embodiments, a portion of the electrical signal that is provided to the modulator is redirected into the laser element using a coupling network that includes a coupling capacitor. This electrically coupled EML device (EC-EML) is described in detail herein connection with illustrative embodiments. Beneficially, the laser changes its frequency (FL=c/λo) according to the filtered current that is fed into it. When a laser is modulated by a small modulation current around a fixed bias point, the laser frequency change (chirp) is directly proportional to the modulation current. This is also true at modulation frequencies that are below the laser resonance frequency, typically well above 10 Ghz.

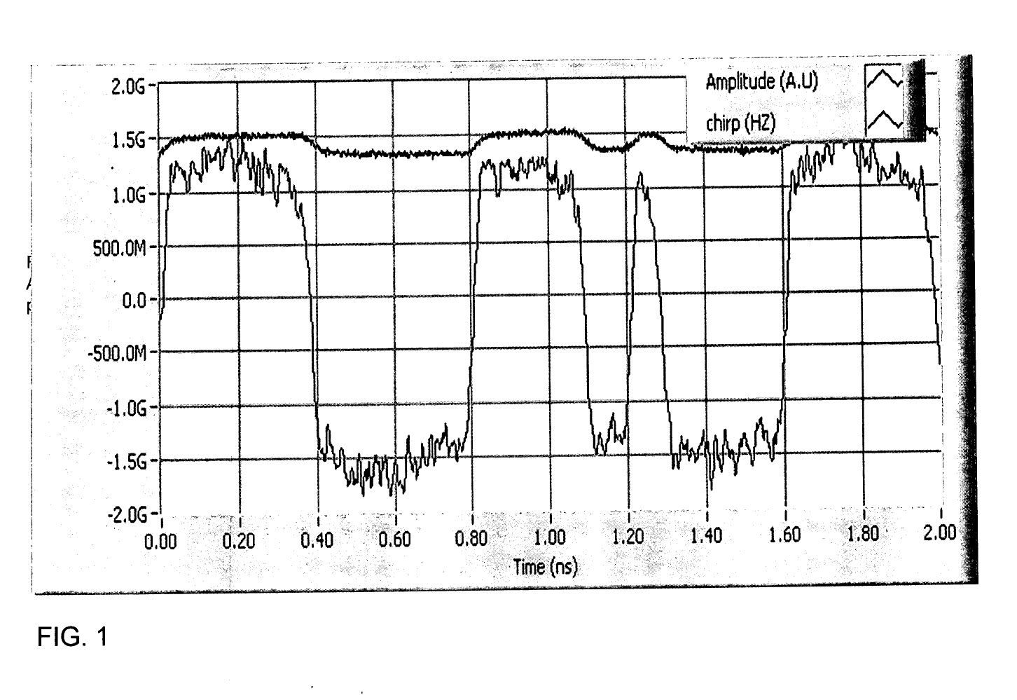

The direct modulation chirp behavior of a typical laser is shown in FIG. 1. Neglecting the oscillatory resonance frequency effects, the chirp is positive so the laser light frequency FL is rising as its amplitude is increasing and falling as the amplitude is decreasing. In contrast to a directly modulated laser, in an EML the modulation is achieved by an external EA modulator which transmits during the “on” high voltage bits and absorbs during the “off” negative voltage bits. This type of modulator introduces dynamic chirp (chirp that occurs only during the rise and fall time of the bit) and not adiabatic chirp (chirp during the constant part of the bit).

In order to change the laser frequency in a useful way that will improve the transmission performance a current signal is added to the laser that follows the modulator signal with a small time delay. Using an LRC circuit or a transistor circuit to feed an RF current signal from the modulator drive signal this desired effect is achieved. The resulting laser frequency change will provide the necessary degree of negative dynamic chirp to improve the overall performance of the integrated device.

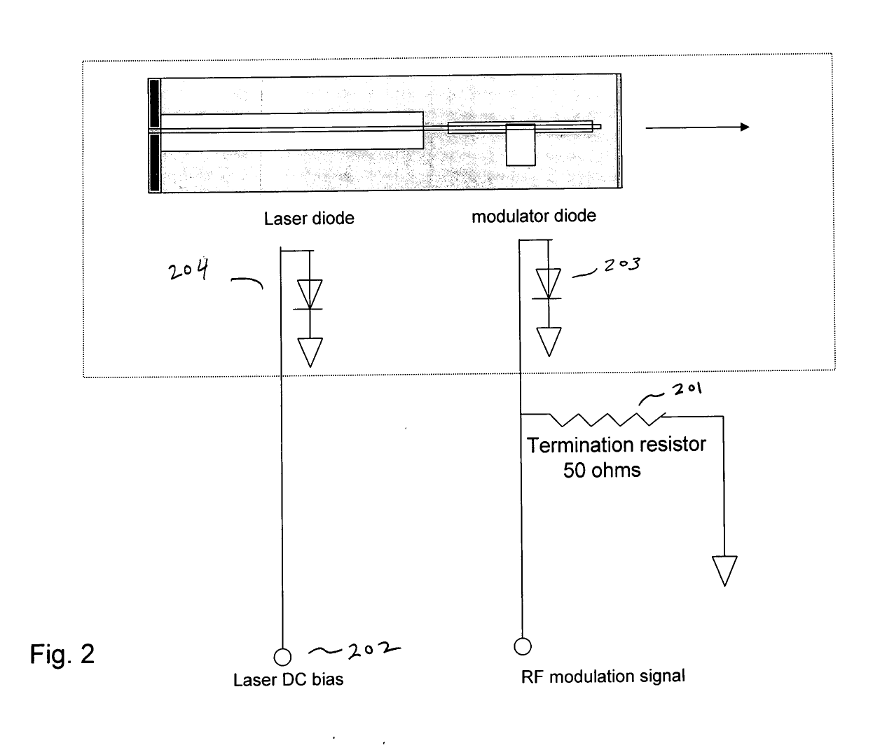

A known EML circuit is shown in FIG. 2. In this known circuit, the RF modulation voltage is fed to the modulator 203, which is terminated by a 50 ohm resistor 201 while the laser 204 is driven by a DC current source 202.

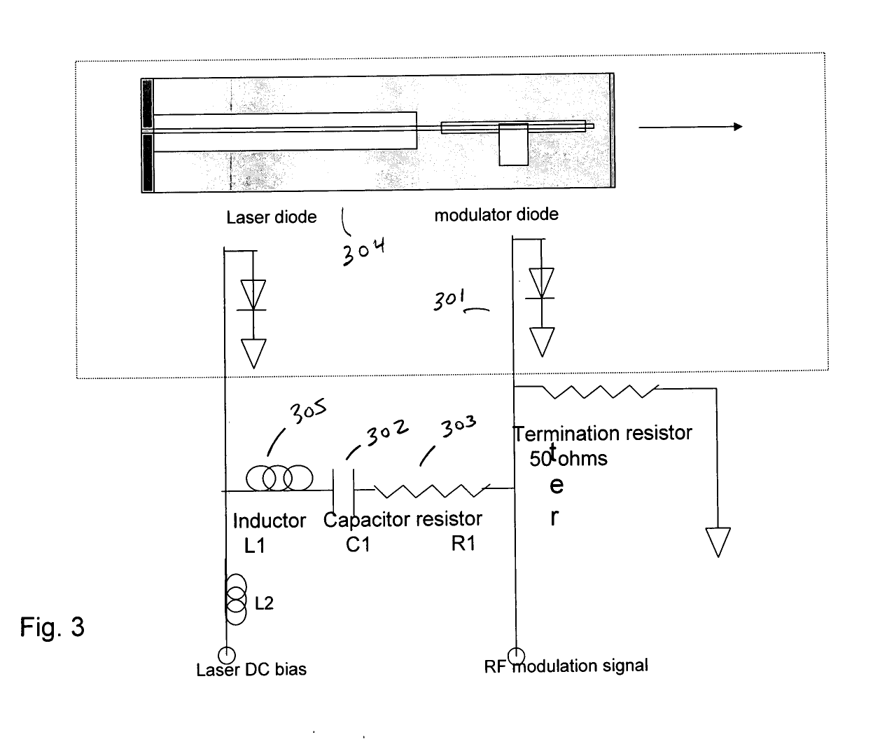

FIGS. 3-6 are schematic diagrams of EML circuits in accordance with the example embodiments. The electrical signal that enters the modulator 301 from an external source is fed through a capacitor 302 and a resistor 303 to the laser 304. Notably, the bonding wires of predetermined length provide connections to various elements and are shown as inductor 305. Typical values of the bond wire inductance are in the range of approximately 1.0 nH and approximately 5.0 nH while the resistor 303 and capacitor 302 are approximately 300 ohms and approximately 2.0 pf to approximately 5.0 pf, respectively.

The RC combination creates an electrical high-pass filter which passes only electrical frequencies above the filter cut-off frequency and prevents DC coupling between the modulator 301 and the laser 304. In addition the digital signal of the modulator is being passed through an LC circuit creating a delayed laser current pulses which have the desired effect on the combined chirp.

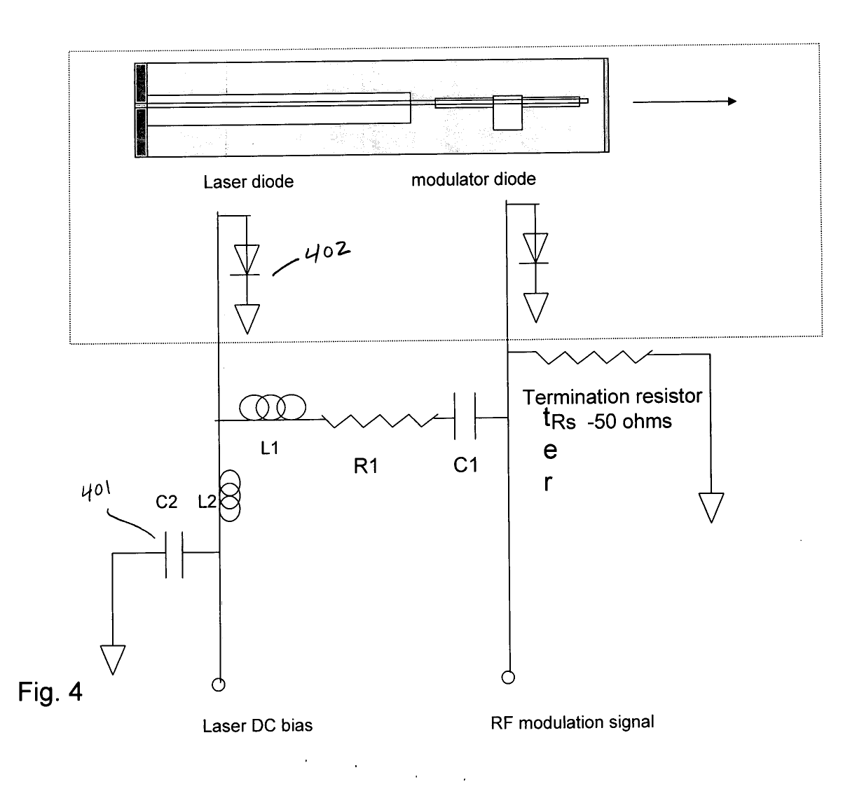

FIG. 4 is a schematic diagram of an EML in accordance with another example embodiment. In the present embodiment, an additional capacitor 401 (C2) is connected in parallel to the laser diode 402, which is used to prevent low frequency pick up noise. In the present embodiment, the laser capacitor (C2) 401 is connected to the laser 402 by a relatively long bond wire inductor L2. This aids in preventing the laser capacitor 401 from smoothing out the short chirp correction pulses. The inductance L2 is chosen so that it provides enough impedance to prevent shorting the high frequency pulses coupled to the laser through capacitor C1. Typically this inductance can be 1-3 nH.

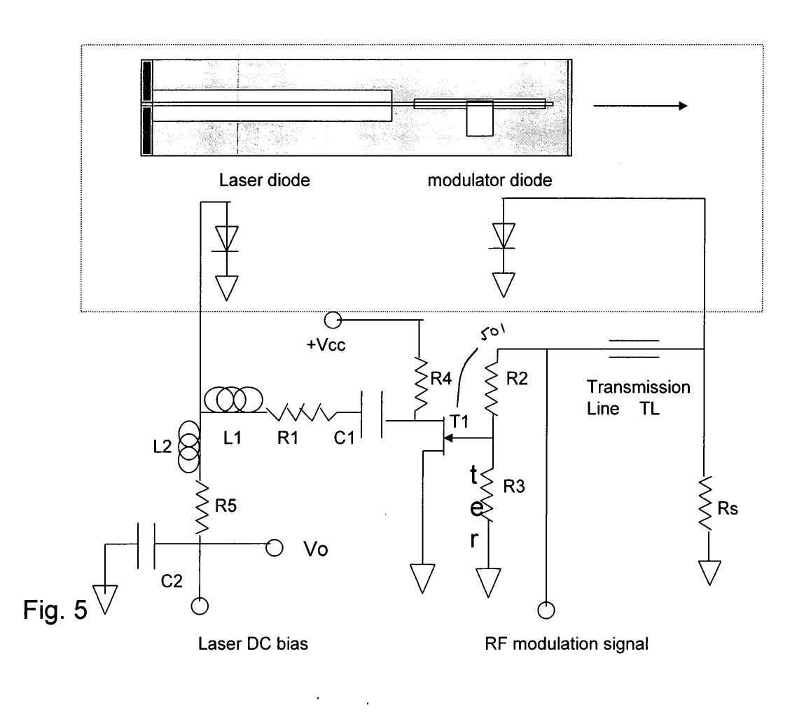

FIG. 5 is a schematic diagram of an EML in accordance with another example embodiment. In the present example embodiment, the RF signal to the laser is driven by a field effect transistor (FET) T1 501 with a biasing resistor network R2, R3 R4, The RF signal applied to coupling capacitor C1 is inverted in polarity in comparison to the signal applied to the modulator 301. In this example embodiment, the modulator 301 is more transmitting when the input signal voltage is rising and more absorbing when the signal voltage is falling (becoming more negative). As shown in FIG. 5 the modulation signal is coupled to the laser through the polarity inverting transistor and coupling capacitor C1. As described above the frequency of the laser will decrease as the input RF signal is rising and increase when the input RF signal is falling. The end result is that laser negative chirp is added to the modulator chirp and the total chirp can be made negative. Typically, the values of the components are approximately L=0.1-0.5 nH, R=0-40 ohms and C=0.2-0.5 pF. In this embodiment, the time derivative of the input electrical signal is coupled into the laser through the differentiating capacitor C1. The laser DC bias current is superimposed with an RF signal component that is proportional to the inverse derivative of the input RF signal. This introduces an effective negative dynamic chirp to the EML improving the transmission performance of the device. The transistor used can be a high frequency Ga-As based heterojunction field effect transistor (HJ-FET) such as NEC-NE321000 or similar. Notably, the transistor T1 in FIG. 5 is shown as a field effect transistor but a suitably biasedbipolar transistor (HBT) could also serve the same purpose. It should also be noted that the transistor T1 in FIG. 5 is shown for clarity as biased with a positive external voltage Vcc but it could be biased (without loss of generality) from the positive laser bias source shown as Vo in FIG. 5 so that an additional bias source for the transistor T1 is not essential for this embodiment of this example.

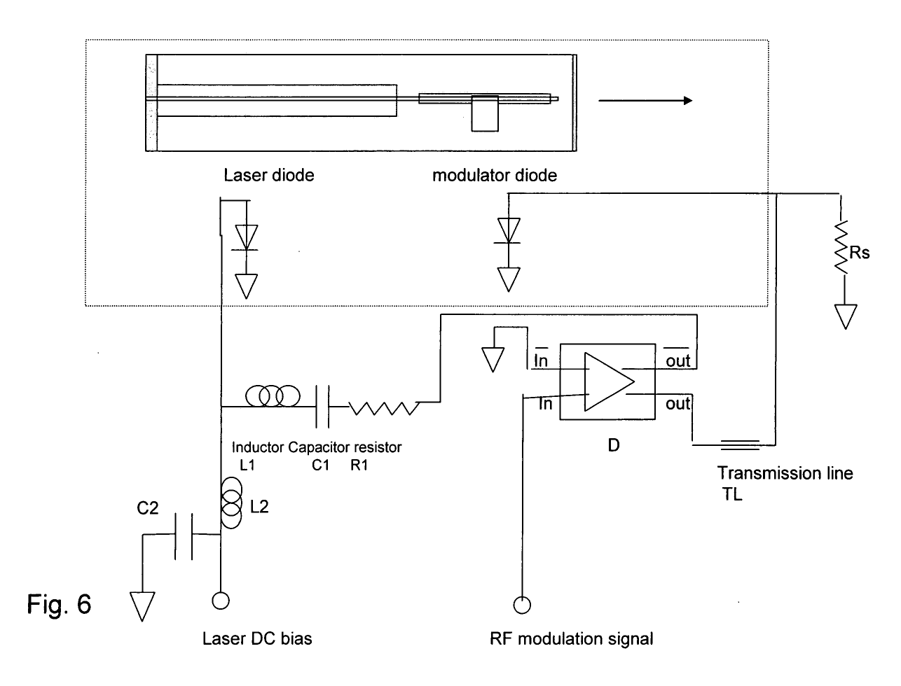

FIG. 6 is a schematic diagram of an EML in accordance with yet another example embodiment. In the present embodiment, the modulator is driven by an integrated circuit (IC) driver that inverts the polarity of the input signal. In this case a transmission line TL with a time delay similar to the laser coupling circuit is added in series to the modulator to synchronize the chirp correction signal with the drive signal to the modulator. The TL is typically composed of a micro-stripline ceramic element with appropriate length chosen so that its delay time is in the range of 20-40 psec corresponding to the appropriate delay time of the transistor and RLC circuit.

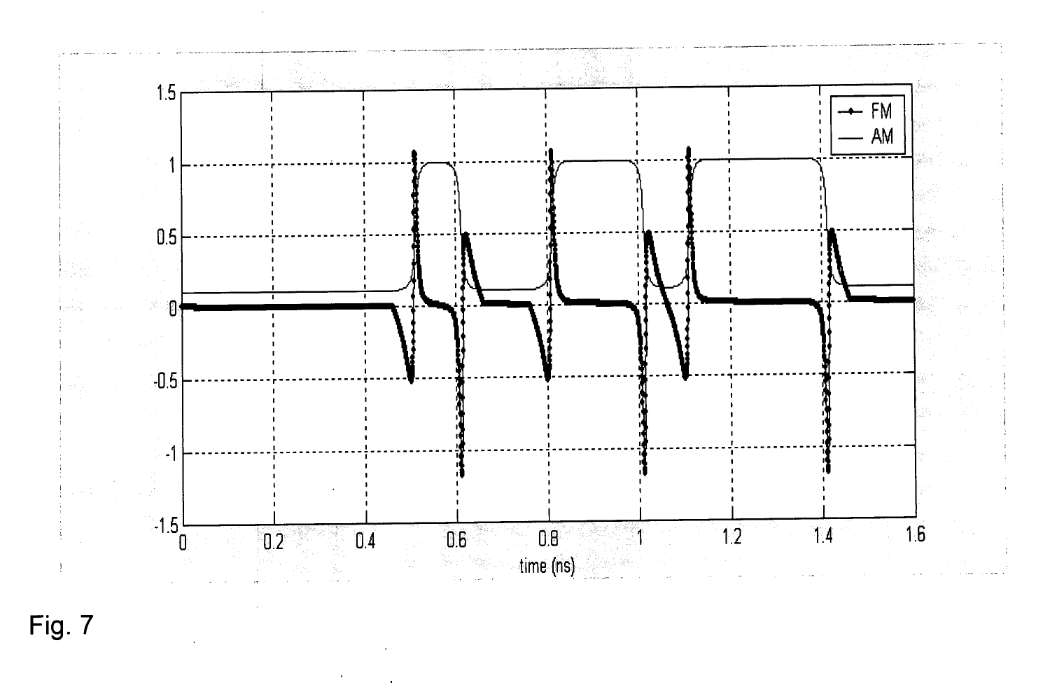

A calculated time resolved chirp pattern for a conventional EML is shown in FIG. 7. The light output amplitude from the modulator and the time resolved output light frequency are shown. In particular, amplitude (AM) and frequency (FM) of output signal are shown. The fast frequency excursions at the rise and fall time of the digital bits are caused by the dynamic chirp of the modulator. Notably, the modulator chirp parameter (α) is changing sign as the voltage across the modulator is varied and the fast changing positive chirp components are mainly responsible for the degradation in transmission performance of the device.

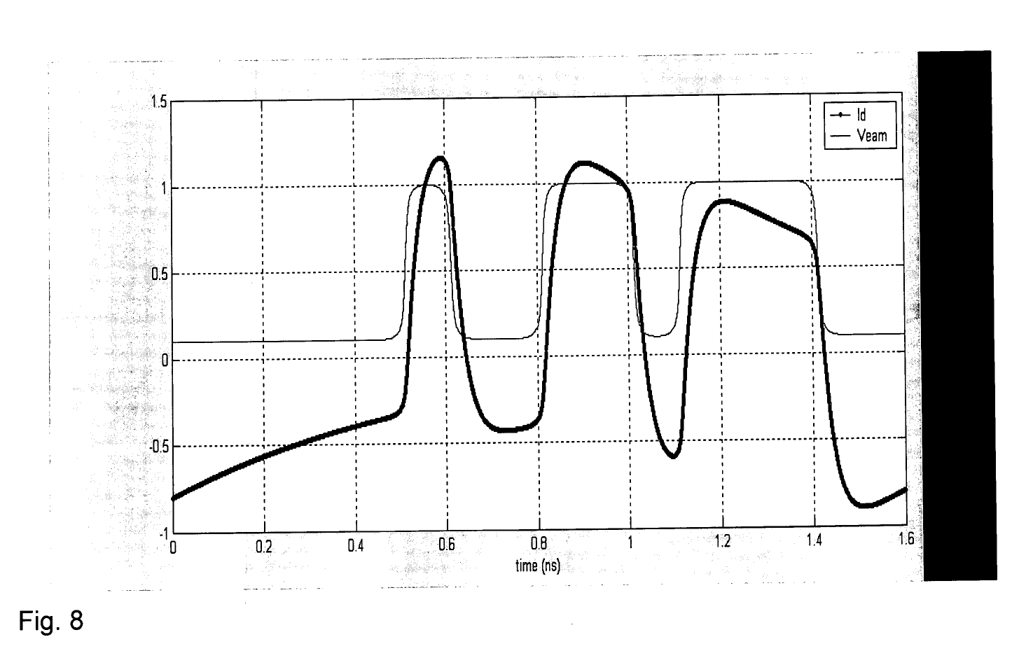

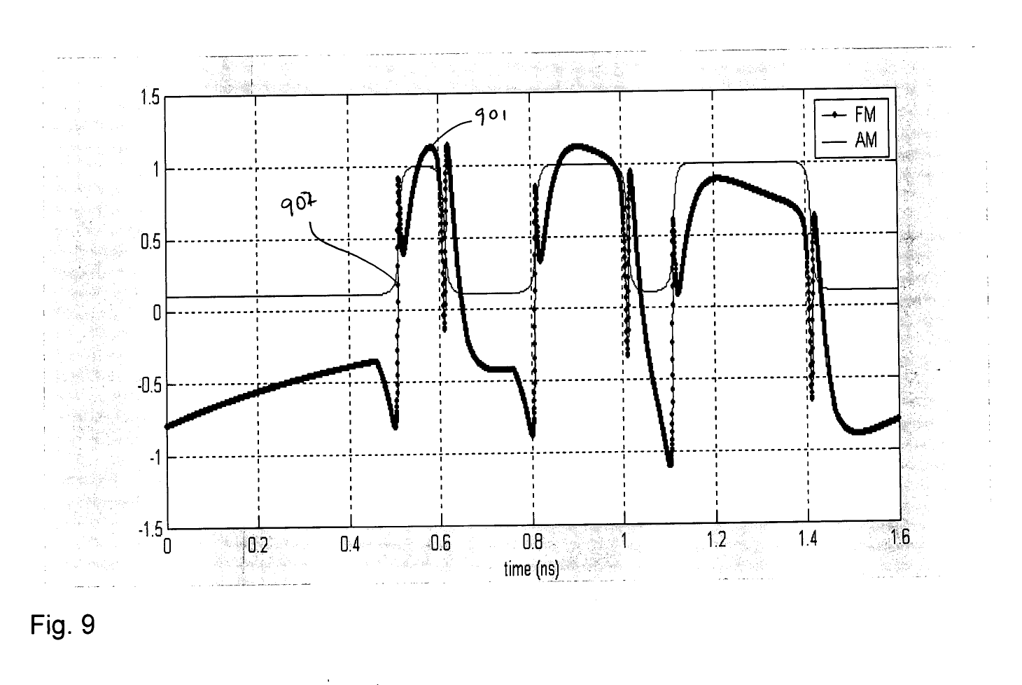

For the proposed EC-EML device of FIG. 3, a simulated calculation of the current IL with the circuit of FIG. 3 using R1=300 ohm, C1=4 pF and L1=5 nH is shown in FIG. 8. The modulator 301 and the RF current fed to the laser by the electrical coupling circuit are shown. From the calculated current injection the additional chirp that this laser modulation would add to the inherent modulator chirp is estimated. The calculated combined chirp of the EC-EML device of FIG. 3 is shown in FIG. 9 with a modulator light output amplitude 901 and the time resolved output light frequency 902. In particular, amplitude (AM) and frequency (FM) of output signal are shown.

Notably, the fast dynamic chirp frequency excursions are smaller than in the conventional EML case. The slowly varying adiabatic chirp components that are added are not degrading the transmission performance.

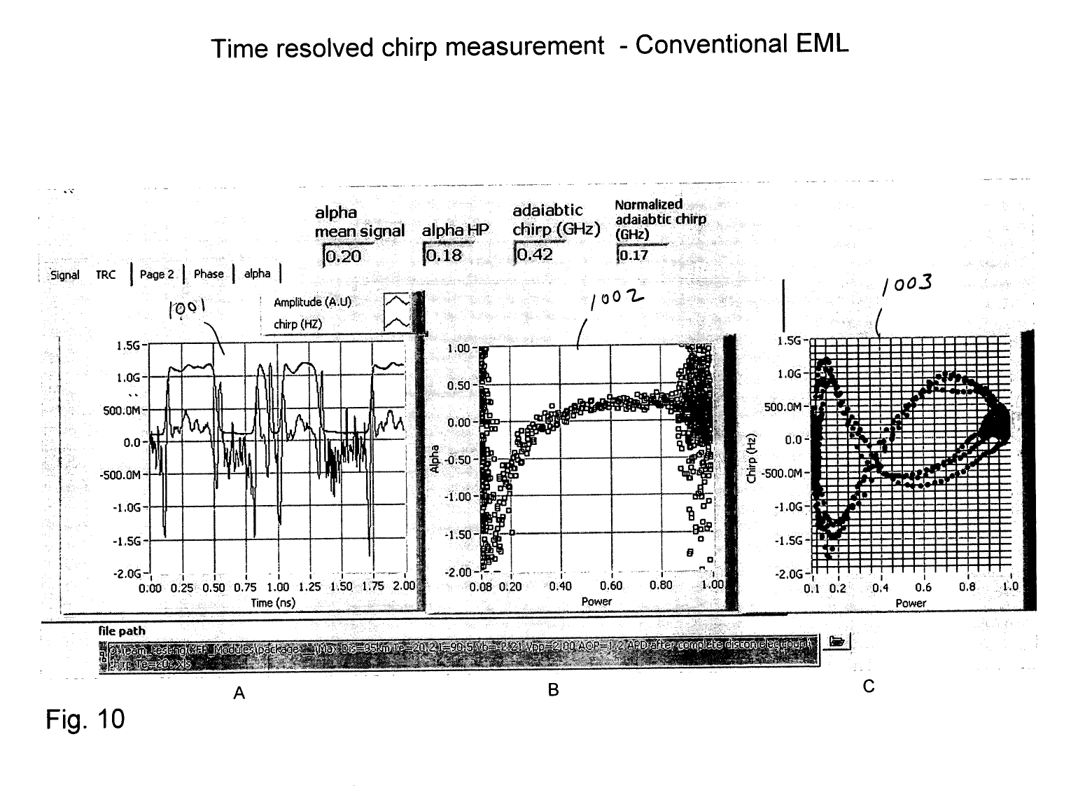

FIG. 10 shows measured experimental results that are consistent with the simulated results of FIG. 9. FIG. 10 shows a time resolved chirp measurement with a conventional EML. The output 1001 (A) shows a time resolved amplitude and frequency pattern of the output light. The output 1002 (B) shows the measured α parameter values as a function of relative output power during the bit pattern. The output 1003 (C) and FIG. 10c shows the corresponding “fish” diagram showing the output light frequency values measured as a function of output power during the measured bit pattern.

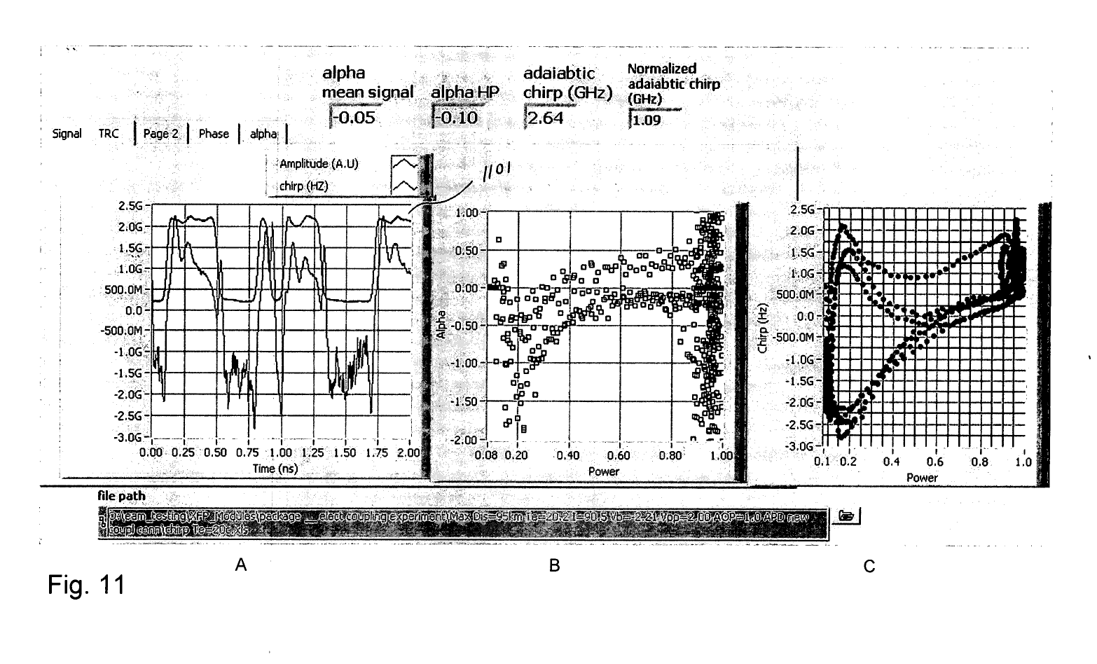

Similarly, the respective measured results are also shown in FIG. 11 for the electrically coupled (EC) EML device of the example embodiment of FIG. 3. The improvement obtained due to the coupling circuit in the EC-EML is clear to see. To this end, the average chirp parameter α at half power is reduced from +0.18 to −0.1. In addition one can see from a comparison of the output 1001 and 1101 that the zero chirp (crossing) point of the diagram is increased from 0.4 relative output power to 0.6 relative output power.

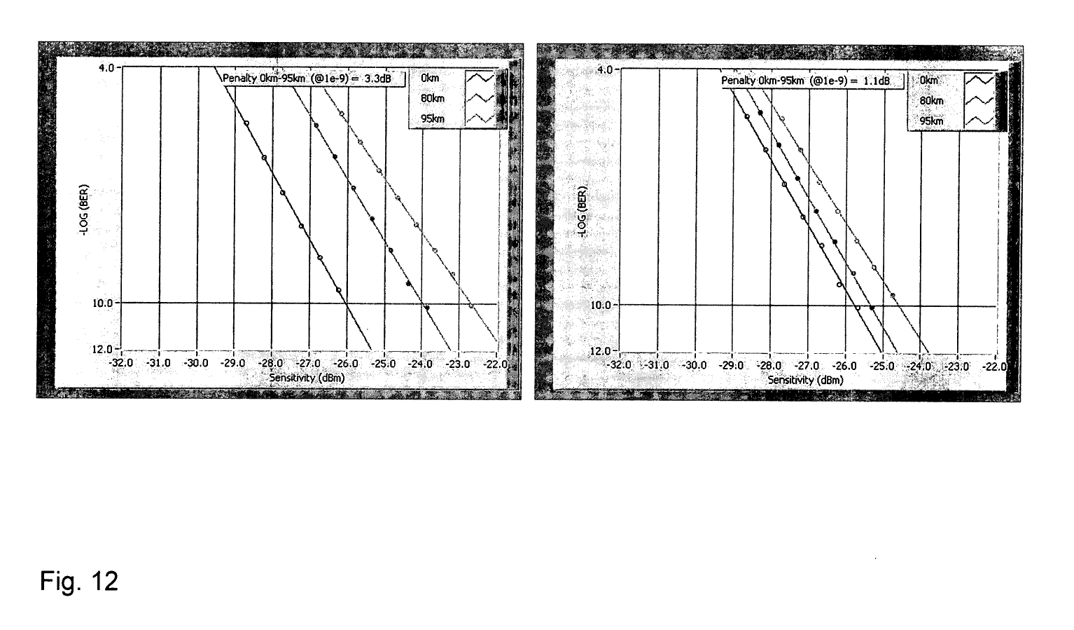

FIG. 12 shows a comparison between the bit error rate (BER) patterns after transmission over 95 km with the same AOP of 1 dBm for the EML device and for the EC-EML using the chip with the proposed electrical coupling scheme. Notably, a significant improvement in transmission performance was obtained for the EC-EML where the DP was reduced from an unacceptable value of 3.3 dB to only 1.1 dB in the case of the electrically coupled device.

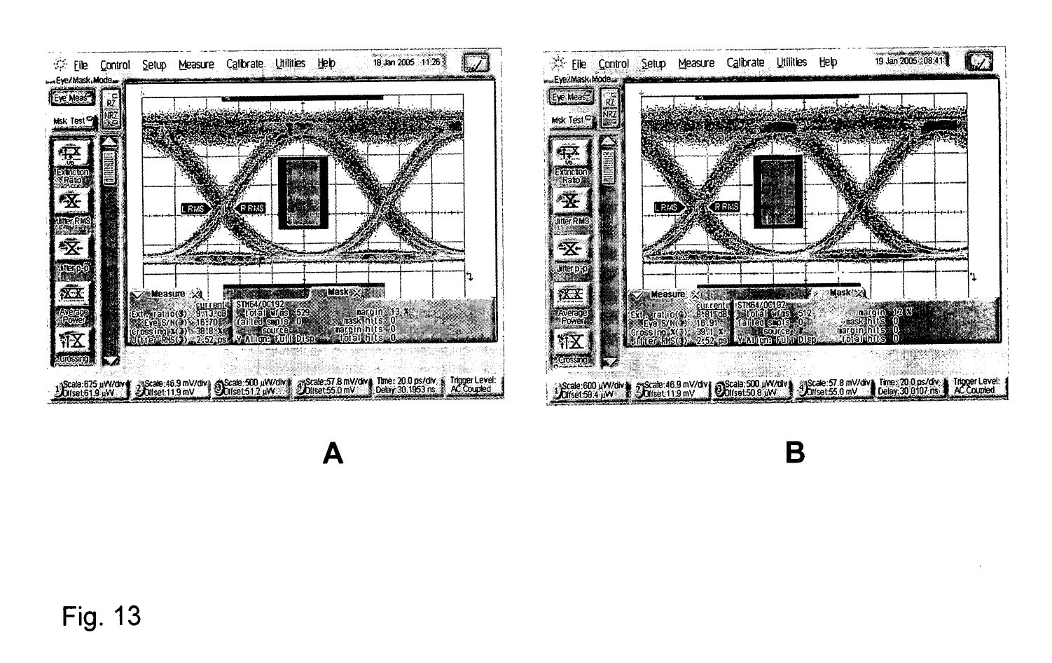

The back to back (BTB) eye diagrams of an EML with conventional 50 ohms termination and with the electrical coupling scheme described in FIG. 3 are shown in FIG. 13 as graphs A and B, respectively, showing there is no degradation of the BTB eye diagram and mask margin due to the proposed electrical coupling scheme.

In accordance with illustrative embodiments described, an EC-EML is adapted to provide optical signals. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. An electroabsorption modulated laser (EML), comprising:
a radio frequency (RF) input to a modulator;
a laser direct current (DC) bias input;
an electrical circuit including a coupling capacitor connecting between the RF input and the laser bias input.

2. An electroabsorption modulated laser (EML) as recited in claim 1, wherein and electrical signal coupled from the RF input to the laser induces time dependent frequency variations in the laser light output.

3. An electroabsorption modulated laser (EML) as recited in claim 2, wherein the time dependent frequency variations produced by the laser and the modulator result in negative total chirp and improves the overall fiber transmission performance.

4. An EML as recited in claim 1, wherein the electrical circuit is an resistor, inductor, capacitor (RLC) serial circuit.

5. An EML as recited in claim 1, wherein the inductor is a wire connection having a parasitic inductance.

6. An EML as recited in claim 1, further comprising an LC circuit coupled to the laser DC bias input.

7. An EML as recited in claim 1, further comprising a polarity-inverting transistor circuit coupled to the RF input, wherein the transistor circuit reverses the polarity of an RF modulation signal

8. An EML as recited in claim 1, further comprising a transmission line used as a delay line to synchronize between the modulator signal and the chirp correction signal coupled to the laser.

9. An EML as recited in claim 2, further comprising a transmission line used as a delay line to synchronize between the modulator signal and the chirp correction signal coupled to the laser.

10. An EML as recited in claim 3, further comprising a transmission line used as a delay line to synchronize between the modulator signal and the chirp correction signal coupled to the laser.

11. An EML as recited in claim 1 further comprising of an integrated circuit (IC) driver coupled to the RF input, wherein the IC driver provides proportional signals with reverse polarity to the modulator and to the coupling capacitor to the laser.

12. An EML as recited in claim 1 wherein a reduced chirp is provided to increase an output power if the device.

13. An EML as recited in claim 1, wherein a reduced chirp is provided to increase a transmission distance of the device through dispersive optical fiber.
